(19) United States
(12) Patent Application Publication
(10) Pub. No.: US 2012/0249342 A1
(43) Pub. Date: Oct. 4, 2012

(54) MACHINE DISPLAY SYSTEM

(76) Inventors: Craig L. KOEHRSEN, East Peoria, IL (US); Aaron M. DONNELLI, Metamora, IL (US); Clay D. REITZ, Morton, IL (US)

(21) Appl. No.: 13/077,575

(22) Filed: Mar. 31, 2011

(51) Int. Cl. G08G 1/00

(52) U.S. Cl. 340/904

(57) ABSTRACT

A display system for a mobile machine operating at a worksite is disclosed. The display system may have an obstacle detection device configured to detect objects within a distance of the mobile machine, and a locating system configured to track objects at the worksite. The display system may also have a display located within the mobile machine, and a controller in communication with the obstacle detection device, the locating system, and the display. The controller may be configured to cause information from the obstacle detection device and the locating system to be simultaneously shown in an overlapping manner on a common portion of the display.

### TECHNICAL FIELD

The present disclosure is directed to a display system and, more particularly, a system for displaying within a mobile machine the machine's environmental surroundings.

### BACKGROUND

Mobile machines such as haul trucks, excavators, motor graders, backhoes, water trucks, and other large equipment are utilized at a common worksite to accomplish a variety of tasks. At these worksites, because of the size of these machines, lack of visibility, slow response time, and difficulty of operation, operators should be keenly aware of their surroundings. Specifically, each operator should be aware of the location of stationary objects at the worksite, road conditions, facilities, and other mobile machines in the same vicinity. Based on the speed of a particular machine, and its size and response profile, the operator of the machine should respond differently to each encountered obstacle in order to avoid collision and damage to the machine, the objects at the worksite, and the other mobile machines. In some situations, however, there may be insufficient warning for the operator to adequately maneuver the machine away from damaging encounters.

One way to help reduce the likelihood of damaging encounters is disclosed in U.S. Patent Publication No. 2009/0259401 of Edwards et al. that published Oct. 15, 2009 (the '401 publication). Specifically, the '401 publication discloses a collision avoidance system that includes an obstacle sensor such as a motion detector, an RFID detector, a GPS tracking system, a LIDAR device, a RADAR device, or a Sonar Device; a camera; and a display such as a monitor, an LCD screen, or a plasma screen located within a cab of a machine. The display shows captured images from the motion detector of obstacles on a visual representation of a worksite (i.e., on an electronic map). The display can operate in a mixed mode, where a first portion of the display is devoted to the map with the obstacles shown on the map, a second portion is devoted to images from the camera, and a third portion is devoted to status information. By using the collision avoidance system, a machine operator may be more aware of machine surroundings and better able to avoid collision with the obstacles.

Although the collision avoidance system of the '401 publication may help to avoid obstacle collision, it may be less than optimal. In particular, the display disclosed in the '401 publication may be unable to simultaneously show obstacle information obtained from multiple sources in an overlapping manner on the electronic map. Without this ability, some knowledge regarding the obstacles could be lost and/or misinterpreted.

The disclosed machine display system is directed to overcoming one or more of the problems set forth above and/or other problems of the prior art.

### SUMMARY

One aspect of the present disclosure is directed to a display system for a machine operating at a worksite. The display system may include an obstacle detection device configured to detect objects within a distance of the mobile machine, and a locating system configured to track objects at the worksite. The display system may also include a display located within the mobile machine, and a controller in communication with the obstacle detection device, the locating system, and the display. The controller may be configured to cause information from the obstacle detection device and the locating system to be simultaneously shown in an overlapping manner on a common portion of the display.

Another aspect of the present disclosure is directed to a method of machine display. The method may include detecting objects at a worksite within a distance of a mobile machine, and tracking positions of objects at the worksite. The method may further include simultaneously displaying information associated with detected objects and tracked objects in an overlapping manner on a common portion of a display device within the mobile machine.

### BRIEF DESCRIPTION OF THE DRAWINGS

FIG. 1 is a diagrammatic illustration of an exemplary disclosed machine; and

FIGS. 2 and 3 are pictorial illustrations of an exemplary disclosed display system that may be used in conjunction with the machine of FIG. 1.

### DETAILED DESCRIPTION

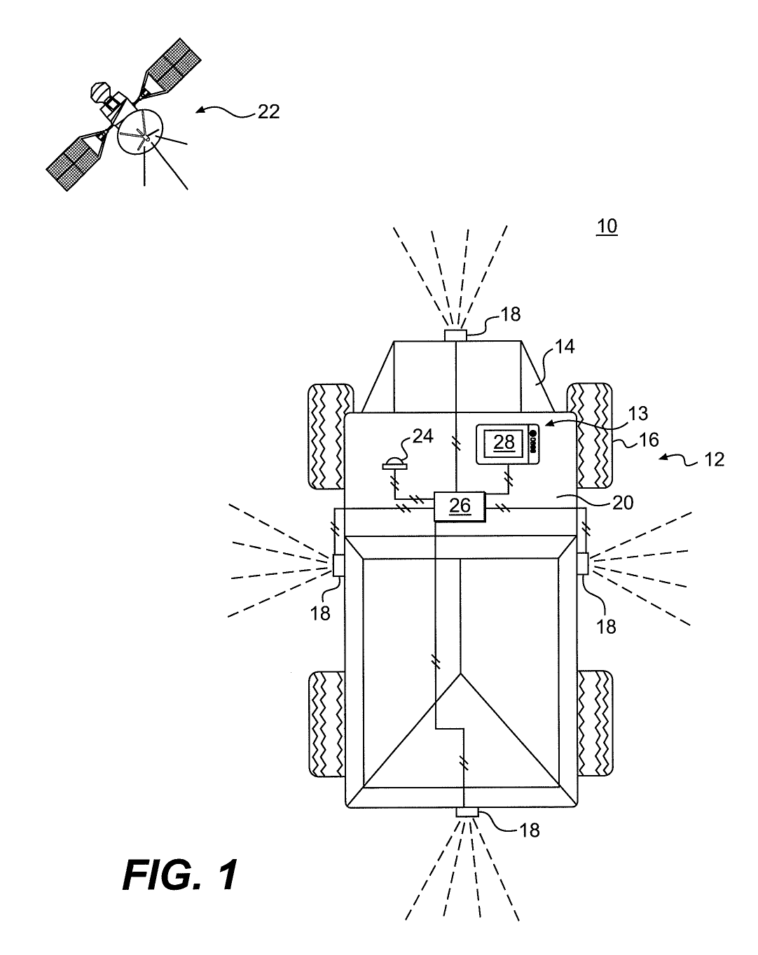

FIG. 1 illustrates an exemplary worksite 10 with a machine 12 performing a predetermined task at worksite 10. Worksite 10 may include, for example, a mine site, a landfill, a quarry, a construction site, a road worksite, or any other type of worksite. The predetermined task may be associated with any work activity appropriate at worksite 10, and may require machine 12 to generally traverse worksite 10. Any number of machines 12 may simultaneously and cooperatively operate at worksite 10, as desired.

Machine 12 may embody any type of machine. For example, machine 12 may embody a mobile machine such as the haul truck depicted in FIG. 1, a service truck, a wheel-loader, a dozer, or another type of mobile machine known in the art. Machine 12 may include, among other things, a body 14 supported by one or more traction devices 16, and a plurality of obstacle detection sensors 18 mounted to body 14 and used for environmental display within an operator station 20 of machine 12. As machine 12 travels about worksite 10, a Global Navigation Satellite System (GNSS) 22 or other tracking device or system may communicate with an onboard locating device 24 to monitor the movement of machine 12 and other known objects at worksite 10.

In one embodiment, machine 12 may be equipped with short range sensors 18, medium range sensors 18, and/or long range sensors 18 located at different positions around body 14 of machine 12. Each sensor 18 may be a device that detects and ranges objects, for example a LIDAR (light detection and ranging) device, a RADAR (radio detection and ranging) device, a SONAR (sound navigation and ranging) device, a camera device, or another device known in the art. In one example, sensor 18 may include an emitter that emits a detection beam to a particular zone within a detection range around machine 12, and an associated receiver that receives a reflection of that detection beam. Based on characteristics of the reflected beam, a distance and a direction from an actual sensing location of sensor 18 on machine 12 to a portion of the sensed object within the particular zone may be determined. Sensor 18 may then generate a signal corresponding to the distance, direction, size, and/or shape of the object, and communicate the signal to an onboard controller 26 for subsequent conditioning and presentation on a display 28 within operator station 20.

Operator station 20 may house portions of a machine display system 30 that include, among other things, locating device 24, controller 26, and display 28. Display 28 may be located proximate an operator seat (not shown) and be configured to show information relating to known and unknown obstacles within the detection range of machine 12. As will be explained in more detail below, operator station 20 may also include means for receiving input from an operator regarding how the information should be displayed. In one embodiment, display 28, itself, may include hardware and or software that enables the input to be received from the operator of machine 12. In another embodiment, a separate input device (not shown), for example a keyboard, a mouse, a light stick, or another input device known in the art may be included within operator station 20 and communicatively coupled with controller 26 and/or display 28 for receipt of operator input.

One or more locating devices 24 may be associated with machine 12 and other known object, for example other mobile machines and stationary facilities, at worksite 10. Locating devices 24 may cooperate with the components of GNSS 22 and/or another tracking system (e.g., an Inertial Reference System (IRS), a local tracking system, or another known locating system) to determine a position of machine 12 and the other known objects at worksite 10 and to generate corresponding signals indicative thereof. Locating device 24 may be in communication with controller 26 to convey signals indicative of the received or determined positional information and identification of the tracked object(s) for further processing. Controller 26, as will be described in more detail below, may then selectively cause a representation of machine 12 and the other known objects to be shown overlaid at their relative positions on an electronic representation of worksite 10 within display 28 of machine 12.

Controller 26 may embody a single microprocessor or multiple microprocessors that include a means for monitoring the location of machine 12 and the other known and unknown objects at worksite 10, and for displaying information regarding characteristics of machine 12 and the objects within operator station 20. For example, controller 26 may include a memory, a secondary storage device, a clock, and a processor, such as a central processing unit or any other means for accomplishing a task consistent with the present disclosure. Numerous commercially available microprocessors can be configured to perform the functions of controller 26. It should be appreciated that controller 26 could readily embody a general machine controller capable of controlling numerous other machine functions. Various other known circuits may be associated with controller 26, including signal-conditioning circuitry, communication circuitry, and other appropriate circuitry. Controller 26 may be further communicatively coupled with an external computer system, instead of or in addition to including a computer system, as desired.

Display 28 may be any appropriate type of device that provides a graphics user interface (GUI) for presentation of machine and object locations and/or other information to operators of machine 12. For example, display 28 may be a computer console or cab-mounted monitor, an LCD screen, a plasma screen, or another similar device that receives instructions from controller 26 and displays corresponding information. It is contemplated that display 28 may also be configured to receive input from the operator regarding desired modes and/or display functionality, for example by way of a touch screen interface, if desired.

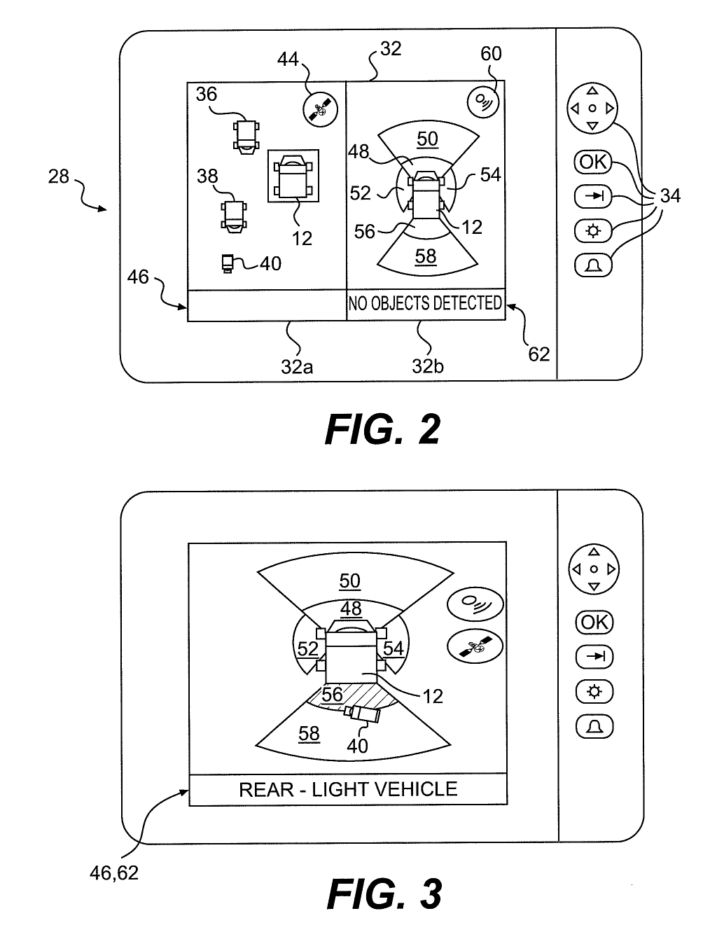

As shown in the particular embodiment of FIG. 2, display 28 may include a screen area 32 and an input area 34. In this embodiment, screen area 32 is divided virtually into a first screen portion 32a associated with display of information received or determined via locating device 24 (referring to FIG. 1) and a second screen portion 32b associated with display of information received or determined via obstacle detection sensors 18. It is contemplated that screen area 32 may be divided into as many portions as desired or, alternatively, include only a single screen portion (shown in FIG. 3).

First screen portion 32a may be configured to show a representation of machine 12 in its environment at worksite 10, for example in an electronic map of worksite 10. Specifically, first screen portion 32a may be configured to show a representation of machine 12 relative to the terrain of worksite 10 and/or the locations of other known objects at worksite 10 that are being tracked via GNSS 22/locating device 24 (referring to FIG. 1). For example, FIG. 2 shows machine 12 located in a general center of first screen portion 32a and outlined in a box shape, with three other known objects shown at their respective locations relative to machine 12 (as tracked by components GNSS 22/locating device and remotely communicated to controller 26). In this example, the other known objects may be other mobile machines operating at worksite 10, with corresponding characteristics such as relative size, shape, type, identification, travel direction, speed, and other parameters represented by related images on first screen portion 32a. Specifically, two objects 36, 38 are shown in FIG. 2 as haul trucks similar to machine 12 in size and shape and traveling in an opposing direction relative to machine 12, and a third object 40 is shown as a service truck having a different size and shape and being located farther from machine 12 in a rearward direction. An electronic symbol 44, located at an upper right corner of first screen portion 32a, may indicate that the information displayed in first screen portion 32a is information obtained via GNSS 22/locating device 24. In one example, electronic symbol 44 may resemble a satellite. An information bar 46 may be located at a bottom of first screen portion 32a to provide supplemental information regarding the known objects shown in first screen portion 32a and/or status information regarding GNSS 22, locating device 24, and/or machine display system 30

Second screen portion 32b may have properties similar to first screen portion 32a. In particular, second screen portion 32b may also be configured to show a representation of machine 12 in its environment at worksite 10. Specifically, second screen portion 32b may be configured to show machine 12 relative to particular zones around machine 12 that are scanned by obstacle detection sensors 18 (referring to FIG. 1). For example, FIG. 2 shows machine 12 located in a general center of second screen portion 32b, with multiple zones shown around machine 12, each zone associated with at least one of obstacle detection sensors 18. In this example, six different zones are illustrated, including a forward long-range zone 48, a forward close-range zone 50, a left-side zone 52, a right-side zone 54, a rearward long-range zone 56, and a rearward short-range zone 58. When particular obstacle detection sensors 18 detect obstacles having particular characteristics (e.g., obstacles being at least a certain size or having a certain shape) and send signals indicative of these characteristics to controller 26 (referring to FIG. 1), controller 26 may cause the corresponding one of zones 48-58 to be highlighted on second screen portion 32b. For example, based on signals from a short-range rear-mounted obstacle detection sensor 18, controller 26 has caused rearward short-range zone 58 of FIG. 3 to be highlighted. An electronic symbol 60, located at an upper right corner of second screen portion 32b may indicate that the information displayed in second screen portion 32b is information obtained via obstacle detection sensors 18. In one example, electronic symbol 60 may resemble obstacle detection sensor 18. An information bar 62 may be located at a bottom of second screen portion 32b to provide supplemental information regarding the unknown objects detected in zones 48-58 and/or status information regarding obstacle detection sensors 18 and/or machine display system 30. For example, information bar 62 of FIG. 2 informs the operator that no objects have been detected in any of zones 48-58.

Input area 34 may allow the operator of machine 12 to provide instructions regarding display preferences. Specifically, input area 34 may allow the operator to direct how many portions should be provided within screen area 32 and what information should be displayed within each portion. For example, the operator may choose to divide screen area 32 into first and second portions 32a, 32b, as shown in FIG. 2, or alternatively to have only a single screen portion, as shown in FIG. 3. In addition, the operator may choose to display different layers of overlapping information within each screen portion, such as the display of information obtained via only GNSS 22/locating device 24 (shown in first screen portion 32a of FIG. 2), the display of information obtained via only obstacle detection sensors 18 (shown in second screen portion 32b of FIG. 2), or the simultaneous display of overlapping information obtained via both GNSS 22/locating device 24 and obstacle detection sensors 18 (shown in FIG. 3).

Controller 26 may be configured to correlate information obtained via GNSS 22/locating device 24 and obstacle detection sensors 18. In particular, controller 26 may be configured to compare signals received from GNSS 22/locating devices 24 with signals received from obstacle detection sensors 18 to determine if the unknown obstacles detected within zones 48-58 by sensors 18 correspond with the known obstacles being tracked by GNSS 22/locating devices 24. When signals from GNSS 22/locating devices 24 indicate a position of a known object within one of zones 48-58 at about the same time that obstacle detection sensors 18 indicate that an unknown object of similar characteristic to the known object is within the same one of zones 48-58, controller 26 may conclude that the unknown object detected by sensors 18 is, in fact, the known object being tracked by GNSS 22/locating devices 24. In this situation, controller 26 may both highlight the corresponding one of zones 48-58 and generate a representation of the known object at the correct position within that zone. In addition, controller 26 may be configured to record and track via GNSS 22/locating device 24 a position of an unknown object detected by obstacle detection sensors 18, when the position of the detected object does not correspond with the position of a known object already being tracked by GNSS 22. Based on this information, controller 26 may then be configured to update the map of worksite 10 to include the positional information of the newly tracked object. In some embodiments, the operator may be able to input information as to the identification of the newly tracked object at the time of detection, if desired.

### INDUSTRIAL APPLICABILITY

The disclosed machine display system finds potential application within any mobile machine at any worksite where it is desirable to display within the machine an electronic representation of the machine's surrounding environment at the worksite. The disclosed machine display system may be capable of simultaneously displaying overlapping images of information obtained via an obstacle detection sensor and via a GNSS/locating device. By allowing the simultaneous display of this overlapping information, an operator of the associated machine may be able to correlate the information obtained from the different sources and make decisions that are more informed. In addition, the disclosed machine display system may be capable of automatically correlating the information and utilizing information from one source as input to the other source for enhanced obstacle detection and tracking.

It will be apparent to those skilled in the art that various modifications and variations can be made to the machine display system of the present disclosure. Other embodiments will be apparent to those skilled in the art from consideration of the specification and practice of the machine display system disclosed herein. It is intended that the specification and examples be considered as exemplary only, with a true scope being indicated by the following claims and their equivalents.

What is claimed is:

1. A display system for a mobile machine operating at a worksite, comprising:
an obstacle detection device configured to detect objects within a distance of the mobile machine;
a locating system configured to track objects at the worksite;
a display located within the mobile machine; and
a controller in communication with the obstacle detection device, the locating system, and the display, the controller being configured to cause information from the obstacle detection device and the locating system to be simultaneously shown in an overlapping manner on a common portion of the display.

2. The display system of claim 1, wherein the controller is further configured to cause a representation of the mobile machine to be shown on the common portion of the display simultaneous with the information from the obstacle detection device and the locating system.

3. The display system of claim 2, wherein the controller is further configured to cause an electronic map of the worksite to be shown on the common portion of the display simultaneous with the representation of the mobile machine and the information from the obstacle detection device and the locating system.

4. The display system of claim 1, wherein:
the obstacle detection device is a first obstacle detection device;
the display system further includes at least a second obstacle detection device; and
the controller is in further communication with the at least a second obstacle detection device and further configured to cause multiple zones around the mobile machine to be shown on the display, each of the multiple zones associated different ones of the first and the at least a second obstacle detection devices and selectively highlighted based on detection of objects within the multiple zones.

5. The display system of claim 3, wherein the multiple zones include two forward zones, two side zones, and two rearward zones associated with different portions of the range.

6. The display system of claim 1, wherein:
the obstacle detection device is a RADAR device; and
the locating system is a Global Navigation Satellite System.

7. The display system of claim 1, wherein the object tracked by the locating system is another mobile machine.

8. The display system of claim 1, wherein the controller is configured to determine that the objects detected by the obstacle detection device correspond with the objects tracked by the locating system when positions of detected objects are about the same as positions of tracked objects.

9. The display system of claim 8, wherein the controller is configured to record locations of detected objects when positions of detected objects are not about the same as positions of the tracked objects.

10. The display system of claim 8, wherein the information from the obstacle detection device includes at least one of an object identification, an object size, and an object shape.

11. The display system of claim 1, wherein the controller is further configured to:
receive input from an operator of the mobile machine regarding a display preference; and
cause overlapping information from the obstacle detection device and the locating system to be shown on the display based on the input.

12. The display system of claim 11, wherein the controller is further configured to selectively cause the information from the obstacle detection device and the locating system to be separately shown on different portions of the display based on the input.

13. The display system of claim 12, wherein the controller is further configured to selectively cause symbols to be shown on the display indicative of a type of the information shown on the display.

14. A display system for a mobile machine operating at a worksite, comprising:
an obstacle detection device configured to detect objects within a distance of the mobile machine;
a locating system configured to track objects at the worksite;
a display located within the mobile machine; and
a controller in communication with the obstacle detection device, the locating system, and the display, the controller being configured to:
cause an electronic map of the worksite to be shown in the display;
cause a representation of the mobile machine to be shown on the display;
receive input from an operator of the mobile machine regarding a display preference; and
selectively cause information from the obstacle detection device and the locating system to also be simultaneously shown in an overlapping manner on a common portion of the display or cause the information to be separately shown on different portions of the display based on the input.

15. The display system of claim 14, wherein:
the obstacle detection device is a first obstacle detection device;
the display system further includes at least a second obstacle detection device; and
the controller is in further communication with the at least a second obstacle detection device and further configured to cause multiple zones around the mobile machine to be shown on the display, each of the multiple zones associated different ones of the first and the at least a second obstacle detection devices and selectively highlighted based on detection of objects within the multiple zones.

16. The display system of claim 15, wherein the multiple zones include two forward zones, two side zones, and two rearward zones associated with different portions of the range.

17. The display system of claim 14, wherein:
the obstacle detection device is a RADAR device; and
the locating system is a Global Navigation Satellite System.

18. The display system of claim 14, wherein the object tracked by the locating system is another mobile machine.

19. The display system of claim 14, wherein the controller is configured to determine that the objects detected by the obstacle detection device correspond with the objects tracked by the locating system when positions of detected objects are about the same as positions of tracked objects.

20. The display system of claim 19, wherein the controller is configured to record locations of detected objects when positions of detected objects are not about the same as positions of the tracked objects.

21. The display system of claim 20, wherein the information from the obstacle detection device includes at least one of an object identification, an object size, and an object shape.

22. The display system of claim 14, wherein the controller is further configured to selectively cause symbols to be shown on the display indicative of a type of the information shown on the display.

23. A mobile machine, comprising:
at least one traction device;
a body supported by the at least one traction device;
a plurality of RADAR devices mounted to the body and configured to generate a plurality of first signals indicative of characteristics of unknown objects within different zones around the mobile machine at a worksite;
a locating system configured to track a plurality of other mobile machines at the worksite within the different zones and generate a second plurality of signals indicative of characteristics of the plurality of other mobile machines;
an operator station connected to the body;
a display located within the operator station; and
an onboard controller in communication with the plurality of obstacle detection devices, the locating system, and the display, the onboard controller configured to simultaneously:
cause an electronic map of the worksite to be shown on the display;
cause a representation of the mobile machine to be shown on the electronic map; and
cause information associated with the plurality of first and second signals to be simultaneously shown in an overlapping manner on a common area of the electronic map within the different zones.

24. A method of machine display, comprising;
detecting objects at a worksite within a distance of a mobile machine using an obstacle detection device;
tracking positions of objects at the worksite using a locating system; and
simultaneously providing information associated with detected objects and tracked objects in an overlapping manner on a common portion of a display device within the mobile machine.

25. The method of claim 24, further including:
displaying an electronic map of the worksite on the common portion of the display device; and
displaying a representation of the mobile machine on the electronic map, together with the information associated with the detected and tracked objects.

26. The method of claim 24, wherein:
detecting objects includes detecting objects within multiple zones around the mobile machine; and
the method further includes displaying multiple zones around the mobile machine on the display device, and highlighting particular zones of the multiple zones based on the detecting.

27. The method of claim 24, further including:
determining that detected objects correspond with tracked objects when positions of detected objects are about the same as positions of tracked objects; and
recording locations of detected objects when positions of detected objects are not about the same as positions of tracked objects.

28. The method of claim 24, further including:
receiving input from an operator of the mobile machine regarding a display preference; and
displaying selective layers of information on the display device that are associated with detected and tracked objects based on the input.

29. The display system of claim 28, further including selectively displaying symbols on the display device that are indicative of a type of the information included in the layers.
